(19) United States
(12) Patent Application Publication
(10) Pub. No.: US 2026/0175580 A1
(43) Pub. Date: Jun. 25, 2026

(54) PROCESS FOR PRODUCING LIQUID EJECTION HEAD, AND LIQUID EJECTION HEAD

(71) Applicant: CANON KABUSHIKI KAISHA, Tokyo (JP)

(72) Inventors: ASUKA HORIE, Kanagawa (JP); TAKAYUKI ONO, Kanagawa (JP)

(21) Appl. No.: 19/416,101

(22) Filed: Dec. 11, 2025

(30) Foreign Application Priority Data
Dec. 19, 2024 (JP) 2024-223993

(51) Int. Cl. B41J 2/16; B41J 2/14; B41J 29/13

(52) U.S. Cl. CPC B41J 2/1623; B41J 2/14233; B41J 2/161; B41J 29/13; B41J 2202/03

(57) ABSTRACT

The process for producing a liquid ejection head includes: an applying step for applying, to a support part, a first adhesive material for fixing a cover member, and a second adhesive material and a third adhesive material for fixing an element substrate; an activating step for activating the second adhesive material by irradiating the second adhesive material with light; a placing step for placing the element substrate unit on the support part such that the second adhesive material is covered with the cover member; a first curing step for curing the first adhesive material; and a second curing step for curing the third adhesive material. The activating step is performed prior to the placing step. The second curing step is performed after the first curing step.

### BACKGROUND

### Field of the Technology

The present disclosure relates to a process for producing a liquid ejection head, and a liquid ejection head.

### Description of the Related Art

In a liquid ejection head, an element substrate unit that includes an element substrate in which ejection ports for ejecting liquid are formed may be fixed to a support part that supports the element substrate unit, using an adhesive material. To ensure good printing quality in a liquid ejection head, it is important that the element substrate unit be fixed to the support part with high precision.

Japanese Patent Laid-Open No. 2020-175562 discloses a process for producing a liquid ejection head using a first adhesive material which is a photo-curable adhesive material that cures at normal temperature, a second adhesive material that cures at a second temperature higher than the normal temperature, and a third adhesive material that cures at a third temperature higher than the second temperature. According to the producing process disclosed in Japanese Patent Laid-Open No. 2020-175562, positioning and bonding an element substrate to a support substrate (support part) with high precision can be realized.

### SUMMARY

Meanwhile, Japanese Patent Laid-Open No. 2020-175562 does not mention anything about fixing the element substrate unit to the support part with high precision in a case where the element substrate unit is equipped with a cover member for protecting the element substrate.

The present disclosure aims to provide a process for producing a liquid ejection head that allows an element substrate unit to be fixed to a support part with high precision.

A process for producing a liquid ejection head equipped with: an element substrate unit configured to include an element substrate and a cover member, the element substrate including an energy generating element that generates energy for ejecting liquid, the cover member being configured to surround a periphery of the element substrate and have an opening that does not cover an ejection port for ejecting liquid formed in the element substrate; and a support part configured to support the element substrate unit, the process being characterized by including: an applying step for applying, to the support part, a first adhesive material for fixing the cover member, and a second adhesive material and a third adhesive material for fixing the element substrate; an activating step for activating the second adhesive material by irradiating the second adhesive material with light; a placing step for placing the element substrate unit on the support part such that the second adhesive material is covered with the cover member; a first curing step for curing the first adhesive material; and a second curing step for curing the third adhesive material, wherein the activating step is performed prior to the placing step, and wherein the second curing step is performed after the first curing step.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic perspective view of a liquid ejection apparatus that can be applied to an embodiment;

FIG. 2A is an upper perspective view of the bottom surface of a liquid ejection head;

FIG. 2B is an upper perspective view of the top surface of the liquid ejection head;

FIG. 3 is a schematic exploded perspective view of the liquid ejection head that can be applied to an embodiment;

FIG. 4 is a schematic exploded perspective view of an element substrate unit that can be applied to an embodiment;

FIG. 5A is a cross-sectional perspective view of an element substrate;

FIG. 5B is an enlarged cross-sectional perspective view of the element substrate;

FIG. 6 is a flowchart of a process for producing the liquid ejection head that can be applied to an embodiment;

FIG. 7 is an explanatory diagram of S601;

FIG. 8A is a bottom view of a support part after adhesive materials are applied;

FIG. 8B is a cross-sectional view of the top surface of FIG. 8A taken along line VIIIb-VIIIb;

FIG. 9 is an explanatory diagram of S603;

FIG. 10A is a schematic bottom view of the liquid ejection head after the element substrate unit is placed;

FIG. 10B is a cross-sectional view of the top surface of FIG. 10A taken along line Xb-Xb;

FIG. 11A is a diagram illustrating a first modification example of S601;

FIG. 11B is a diagram illustrating a second modification example of S601;

FIG. 12 is a schematic perspective view of the liquid ejection head that can be applied to an embodiment;

FIG. 13 is a schematic exploded perspective view of the element substrate unit that can be applied to an embodiment;

FIG. 14A is a schematic diagram of the liquid ejection head that can be applied to an embodiment; and

FIG. 14B is a cross-sectional view taken along line XIVb-XIVb of FIG. 14A.

### DESCRIPTION OF THE EMBODIMENTS

### First Embodiment

### Liquid Ejection Apparatus 1000

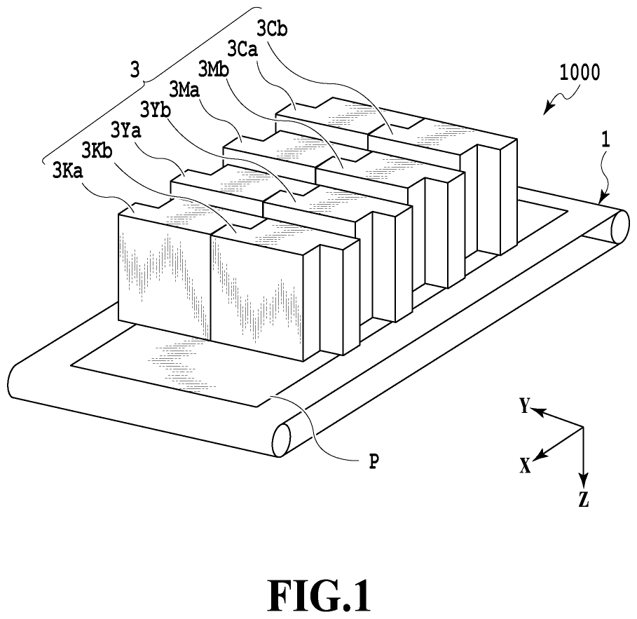

FIG. 1 is a schematic perspective view of the liquid ejection apparatus 1000 that can be applied to the present embodiment.

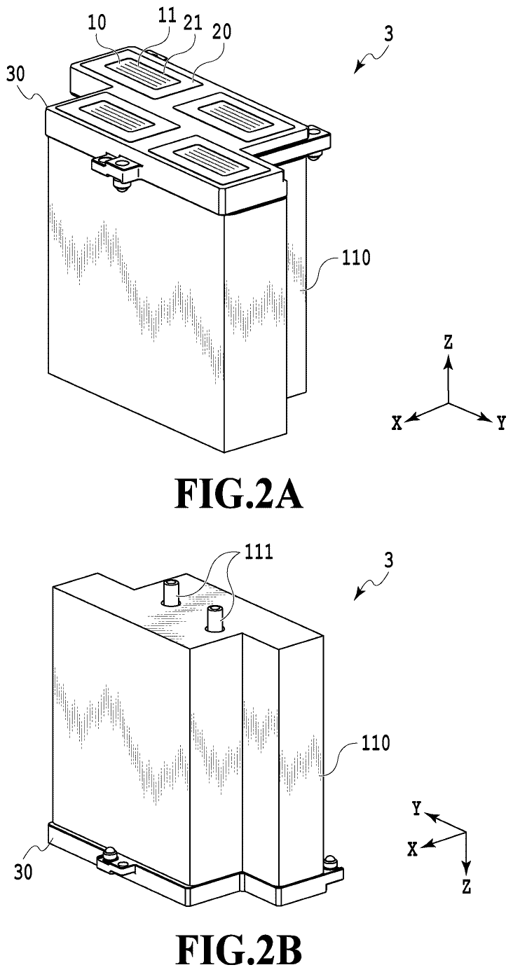

Each of X, Y, and Z axes shown in the drawings referred to in the following description indicates a coordinate axis in the liquid ejection apparatus 1000. The X direction indicates the conveyance direction of the printing medium P. The Y direction indicates the array direction of the ejection ports 11 (see FIG. 2A, etc.) in the element substrate 10 (see FIG. 2A, etc.). The Z direction indicates the ejection direction of liquid (for example, ink) ejected by the liquid ejection head 3. The X direction intersects (in the present embodiment, orthogonally) with the Y direction in a plane. The Z direction intersects (in the present embodiment, orthogonally) with each of the X direction and the Y direction.

The liquid ejection apparatus 1000 illustrated in FIG. 1 prints an image by ejecting liquid (for example, ink) from the liquid ejection head 3 placed at a fixed position while continuously conveying the printing medium P (for example, a cut sheet) in the conveyance direction using the conveyance device 1. In this way, in the present embodiment, an inkjet printing apparatus equipped with what is termed as the full-line type liquid ejection head 3 is used as the liquid ejection apparatus 1000. The liquid ejection head 3 has the ejection ports 11 formed across the side corresponding to the entire width of the printing medium P (the length in the X-axis direction) for ejecting liquid (for example, ink).

In the present embodiment, the liquid ejection head 3 corresponds to four colors: cyan (C), magenta (M), yellow (Y), and black (K). Specifically, the liquid ejection head 3 includes the first liquid ejection head 3Ca and the second liquid ejection head 3Cb that correspond to cyan (C) ink. The liquid ejection head 3 includes the third liquid ejection head 3Ma and the fourth liquid ejection head 3Mb that correspond to magenta (M) ink. The liquid ejection head 3 includes the fifth liquid ejection head 3Ya and the sixth liquid ejection head 3Yb that correspond to yellow (Y) ink. The liquid ejection head 3 includes the seventh liquid ejection head 3Ka and the eighth liquid ejection head 3Kb that correspond to black (K) ink.

The printing medium P is conveyed in the conveyance direction (the X direction) by the conveyance device 1. The liquid ejection head 3 performs printing on the printing medium P.

### Liquid Ejection Head 3

FIG. 2A is a schematic perspective view of the bottom surface of the liquid ejection head 3 that can be applied to the present embodiment, viewed from above.

As illustrated in FIG. 2A, the liquid ejection head 3 is equipped with the head cover 110 that covers the internal configurations.

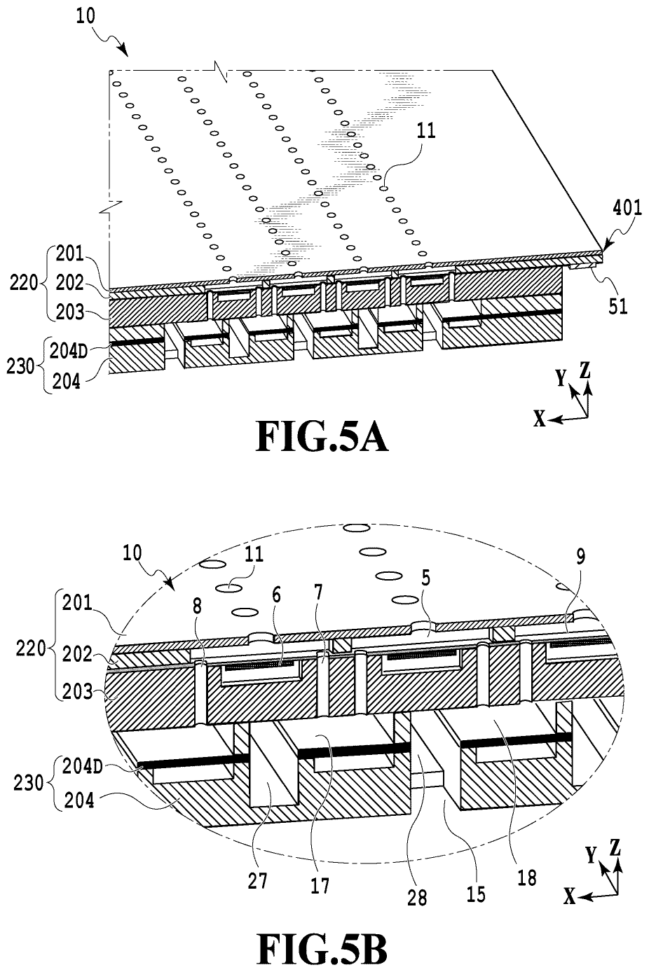

The liquid ejection head 3 is equipped with the element substrate 10 that includes the energy generating elements 6 (see FIG. 5B, etc.) which generate energy for ejecting liquid, the cover member 20 that covers the element substrate 10, and the support part 30 that supports the element substrate 10. The cover member 20 is made of a material that does not transmit light.

Further, in the present embodiment, four element substrates 10 are arranged in a staggered pattern. Note that the number of element substrates 10 is not limited to four. For example, the number of element substrates 10 may be one. Each of these element substrates 10 has the ejection ports 11 for ejecting liquid.

The cover member 20 surrounds the periphery of the element substrate 10. The cover member 20 has the opening 21 that does not cover the ejection ports 11 for ejecting liquid formed in the element substrate 10. In the state where the cover member 20 is attached to the element substrate 10, the ejection ports 11 are exposed through the opening 21.

The element substrate 10 and the cover member 20 are made of different materials. Therefore, the element substrate 10 and the cover member 20 have different linear expansion coefficients. However, it is desirable that the linear expansion coefficient of the cover member 20 be approximately equal to the linear expansion coefficient of the element substrate 10. Specifically, it is desirable that the linear expansion coefficient of the cover member 20 be about 1 to 5 times the linear expansion coefficient of the element substrate 10.

For example, in a case where the element substrate 10 is made of silicon, it is desirable that the cover member 20 be made of titanium, a nickel alloy, stainless steel, tungsten, molybdenum, ceramics, or the like. According to this configuration, the linear expansion coefficient of the cover member 20 can be set within a range of about 1 to 5 times the linear expansion coefficient of the element substrate 10.

Further, it is desirable that the thickness (the length in the Z direction) of the cover member 20 be small. For example, it is desirable that the thickness of the cover member 20 be about 0.1 mm to 0.2 mm. According to this configuration, the cover member 20 does not come into contact with the printing medium P, and the space (the distance in the Z direction) between the ejection ports 11 and the printing medium P during printing can be reduced. In this way, by forming the cover member 20 thin, it is possible to improve the positional accuracy of the liquid to be landed during printing, compared with a case where the cover member 20 is formed thick.

FIG. 2B is a schematic perspective view of the top surface of the liquid ejection head 3 that can be applied to the present embodiment, viewed from above.

As illustrated in FIG. 2B, the liquid connection parts 111 for introducing liquid into the liquid ejection head 3 are installed on the top of the head cover 110. There is no limitation on the number of liquid connection parts 111. In a case where liquid is circulated inside the liquid ejection head 3, the liquid connection parts 111 are configured to be capable of introducing and discharging the liquid.

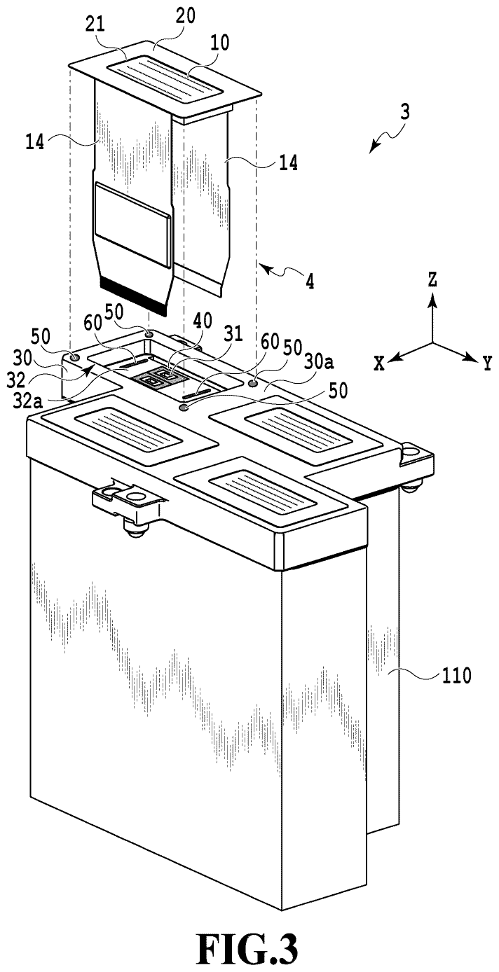

FIG. 3 is a schematic exploded perspective view of the liquid ejection head 3 that can be applied to the present embodiment.

As illustrated in FIG. 3, the liquid ejection head 3 is equipped with the element substrate unit 4 including the element substrate 10, the cover member 20, and the flexible wiring substrates 14 which have flexibility.

In the state where the element substrate unit 4 is fixed to the support part 30, the first adhesive layer including the first adhesive material 50 is formed at a position between the support part 30 and the cover member 20, where light can be irradiated.

In the state where the element substrate unit 4 is fixed to the support part 30, the second adhesive layer including the second adhesive material 60 and the third adhesive layer including the third adhesive material 40 are formed at positions between the support part 30 and the element substrate 10, where light cannot be irradiated.

The first adhesive material 50 is a rapid photo-curable adhesive material that can be cured in a shorter time period than the second adhesive material 60. Therefore, if the first adhesive material 50 cures, the first adhesive layer containing a component which is a rapid photo-curable adhesive material is formed between the support part 30 and the cover member 20.

In the present embodiment, a rapid UV-curable adhesive material is used as the first adhesive material 50. Therefore, if the first adhesive material 50 cures, the first adhesive layer containing a component which is a rapid UV-curable adhesive material is formed between the support part 30 and the cover member 20.

On the other hand, the second adhesive material 60 is a delayed photo-curable adhesive material. Therefore, the time period required for the second adhesive material 60 to cure after being irradiated with light is longer than the time period required for the first adhesive material 50 to cure after being irradiated with light. The curing of the second adhesive material 60 can be delayed by adding a compound that temporarily traps the protons generated by the decomposition of the initiator. For example, by irradiating the second adhesive material 60 with ultraviolet rays, protons of the photo cationic polymerization initiator are generated. These protons are once trapped by the cure retarder and gradually supplied to the polymerization reaction system. In this way, the rate at which the second adhesive material 60 cures can be controlled.

Then, after a certain time period has passed since the irradiation of the ultraviolet rays, the initiator generates acid, which reacts with the acrylic resin, causing cationic polymerization, and thereby the second adhesive material 60 cures. Therefore, if the second adhesive material 60 cures, the second adhesive layer containing a component which is a delayed photo-curable adhesive material is formed between the support part 30 and the element substrate 10.

In the present embodiment, a delayed UV-curable adhesive material is used as the second adhesive material 60. Therefore, if the second adhesive material 60 cures, the second adhesive layer containing a component which is a delayed UV-curable adhesive material is formed between the support part 30 and the element substrate 10.

Further, in the present embodiment, a thermosetting adhesive material is used as the third adhesive material 40. Therefore, if the third adhesive material 40 cures, the third adhesive layer containing a component which is a thermosetting adhesive material is formed between the support part 30 and the element substrate 10.

Further, the support part 30 has flow paths connected to flow paths (described later) formed in the element substrate 10, and the flow path openings 31 of the flow paths. The third adhesive material 40 is applied so as to surround the flow path openings 31, which at least realizes liquid resistance. Therefore, by curing the third adhesive material 40, the third adhesive layer that has liquid resistance and surrounds the flow path openings 31 is formed.

Further, the second adhesive material 60 is applied to a position farther away from the flow path openings 31 compared with the third adhesive material 40. Therefore, by curing the second adhesive material 60, the second adhesive layer is formed at a position farther away from the flow path openings 31 compared with the third adhesive material 40.

In the present embodiment, the recess portion 32 is formed in the bottom surface 30a of the support part 30 (the surface facing the Z direction). In a case where the element substrate unit 4 is placed on the support part 30, the bottom surface 32a of the recess portion 32 is covered by the cover member 20. Therefore, in the state where the element substrate unit 4 is in place on the support part 30, the bottom surface 32a of the recess portion 32 is in a position where light cannot be irradiated. The second adhesive material 60 and the third adhesive material 40 are applied to the bottom surface 32a of the recess portion 32. On the other hand, the first adhesive material 50 is applied to the bottom surface 30a of the support part 30.

In the present embodiment, four element substrate units 4 are arranged in a staggered manner on one main body 300. Note that the number of element substrate units 4 is not limited to four.

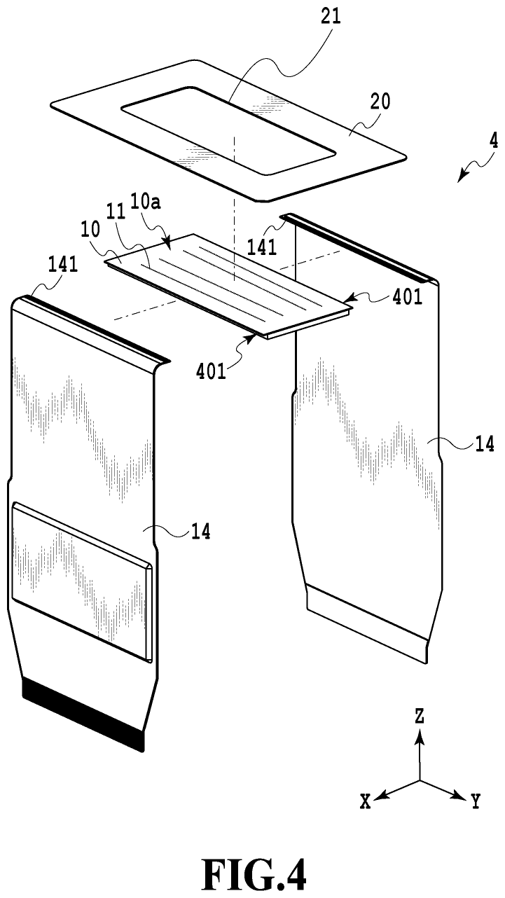

FIG. 4 is a schematic exploded perspective view of the element substrate unit 4 that can be applied to the present embodiment.

As illustrated in FIG. 4, the cover member 20 is fixed to the ejection surface of the element substrate 10 on which the ejection ports 11 are formed. In the present embodiment, the cover member 20 is adhered to the ejection surface 10a using an adhesive material. The thin plate parts 401 are installed on both ends of the element substrate 10 in the X direction. Each of these thin plate parts 401 is equipped with the first electrode part 51 (see FIG. 5A) which includes a plurality of electrodes.

In the present embodiment, the two flexible wiring substrates 14 are attached to one element substrate 10. The flexible wiring substrates 14 are each equipped with the second electrode part 141 which includes a plurality of electrodes for electrically connecting the flexible wiring substrate 14 to the element substrate 10.

By bringing the electrodes of the second electrode parts 141 into contact with the electrodes of the first electrode parts 51, the element substrate 10 and the flexible wiring substrates 14 are electrically connected. By electrically connecting the element substrate 10 and the flexible wiring substrates 14, drive signals and drive power for driving the energy generating elements 6 (see FIG. 5B) are supplied to the element substrate 10 via an electrical wiring substrate (not illustrated in the drawings) and the flexible wiring substrates 14. The cover member 20 is fixed to the ejection surface 10a, in order to prevent liquid from penetrating into the electrical connections between the flexible wiring substrates 14 and the element substrate 10 and to protect the element substrate 10.

### Internal Structure of the Element Substrate 10

FIG. 5A is a schematic cross-sectional perspective view of the element substrate 10 that can be applied to the present embodiment.

As illustrated in FIG. 5A, the element substrate 10 includes the first substrate 220 and the second substrate 230. The first substrate 220 includes the nozzle substrate 201, the liquid chamber substrate 202, and the liquid supply substrate 203. The first substrate 220 is configured by laminating the liquid supply substrate 203, the liquid chamber substrate 202, and the nozzle substrate 201 in this order.

The second substrate 230 is equipped with the flow path forming substrate 204 which includes the damper film 204D that has elasticity. Inside the pressure chambers 5 formed in the first substrate 220 which includes the liquid supply substrate 203 fixed to the flow path forming substrate 204, the pressure fluctuates at the time liquid is ejected. However, the damper film 204D is deformed by the pressure fluctuations occurring inside the pressure chambers 5, and thus the pressure fluctuations occurring inside the pressure chambers 5 can be suppressed. The element substrate 10 is formed by laminating the second substrate 230 and the first substrate 220 in this order.

FIG. 5B is an enlarged perspective view illustrating a part of FIG. 5A enlarged.

As illustrated in FIG. 5B, in the first substrate 220, the liquid chamber substrate 202 includes the diaphragm 9 that has elasticity. In the state where the liquid supply substrate 203, the liquid chamber substrate 202, and the nozzle substrate 201 are laminated in this order, the pressure chambers 5 connected to the ejection ports 11 are formed between the nozzle substrate 201 and the liquid supply substrate 203. For each of the multiple pressure chambers 5, the diaphragm 9 that constitutes a part of the liquid chamber substrate 202 functions as a deformable wall part. The pressure chambers 5 function as flow paths connected to the ejection ports 11.

The diaphragm 9 is equipped with the energy generating elements 6 corresponding to the multiple pressure chambers 5, respectively. In the present embodiment, piezoelectric elements are used as the energy generating elements 6. The energy generating elements 6 are installed at positions corresponding to the multiple ejection ports 11, respectively. The energy generating elements 6 are driven by receiving electric power for ejecting liquid, thereby deforming the diaphragm 9. As the diaphragm 9 deforms, the liquid filled inside the pressure chambers 5 is pressurized. As the liquid filled inside the pressure chambers 5 is pressurized, the liquid is ejected from the ejection ports 11.

The liquid supply substrate 203 is fixed to the surface of the liquid chamber substrate 202 opposite to the surface fixed to the nozzle substrate 201. The liquid supply substrate 203 is formed with the individual supply flow paths 7 for supplying liquid to the pressure chambers 5 and individual collecting flow paths 8 for collecting liquid from the pressure chambers 5. In the state where the liquid supply substrate 203, the liquid chamber substrate 202, and the nozzle substrate 201 are laminated in this order, the individual supply flow paths 7 and the individual collecting flow paths 8 are connected to the pressure chambers 5. The nozzle substrate 201, the liquid chamber substrate 202, the liquid supply substrate 203, and the flow path forming substrate 204 are each made of a material containing silicon or the like.

In the second substrate 230, the flow path forming substrate 204 is formed with the connection flow path 15, the common supply flow path 27, the common supply communication path 17, the common collecting communication path 18, and the common collecting flow path 28. The common supply flow path 27 is connected to the common supply communication path 17. In the state where the second substrate 230 and the first substrate 220 are laminated in this order, one common supply communication path 17 is connected to a plurality of individual supply flow paths 7.

In the state where the second substrate 230 and the first substrate 220 are laminated in this order, a plurality of individual collecting flow paths 8 is connected to one common collecting communication path 18. The common collecting communication path 18 is connected to the common collecting flow path 28. Liquid that has flowed into the common supply flow path 27 from a liquid tank (not illustrated in the drawings) that stores liquid via the connection flow path 15 flows into the individual supply flow paths 7 via the common supply communication path 17 and is supplied to the pressure chambers 5.

As the energy generating elements 6 are driven, the liquid supplied to the pressure chambers 5 is ejected from the ejection ports 11. The liquid that is not ejected flows into the individual collecting flow paths 8.

Further, in a case where the energy generating elements 6 are not driven (for example, in a case where circulation is performed to adjust the temperature of the liquid), all of the liquid supplied to the pressure chambers 5 flows into the individual collecting flow paths 8. The liquid that has flowed into the individual collecting flow paths 8 flows into the common collecting flow path 28 via the common collecting communication path 18, and is then collected into a liquid tank (not illustrated in the drawings) via the connection flow path 15.

### Process for Producing the Liquid Ejection Head 3

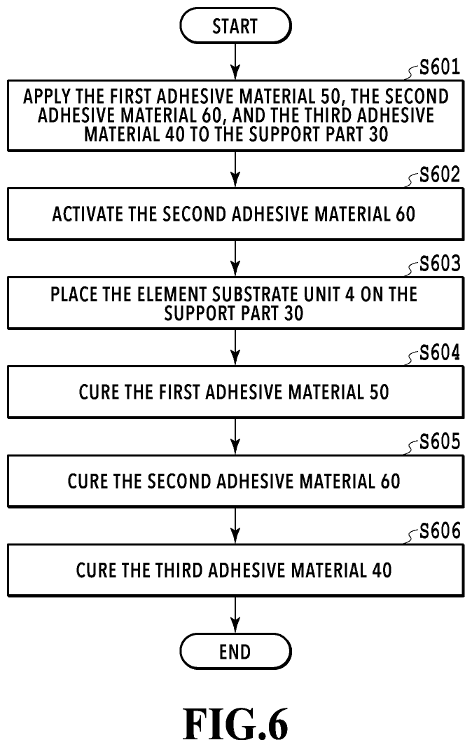

FIG. 6 is a flowchart illustrating a process for producing the liquid ejection head 3 that can be applied to the present embodiment. Note that the symbol “S” in FIG. 6 indicates a step.

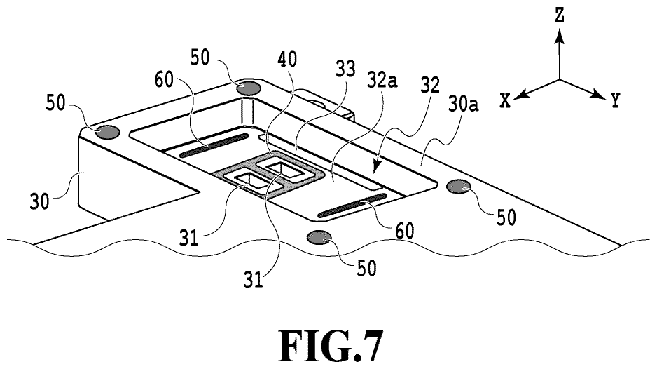

In S601, the first adhesive material 50, the second adhesive material 60, and the third adhesive material 40 (see FIG. 7, etc.) are applied to the support part 30.

FIG. 7 is an explanatory diagram of S601. Note that, for convenience of explanation, the surface facing upward in FIG. 7 is referred to as the “bottom surface.”

As illustrated in FIG. 7, the recess portion 32 is formed in the bottom surface 30a of the support part 30. The bottom surface 32a of the recess portion 32 is formed with the flow path openings 31, which are connected to the connection flow path 15 (see FIG. 5B) in the state where the element substrate unit 4 (see FIG. 3, etc.) is placed on the support part 30. The bottom surface 32a of the recess portion 32 is formed with the wiring openings 33, which are through holes through which the flexible wiring substrates 14 (see FIG. 3, etc.) pass in the state where the element substrate unit 4 is placed on the support part 30.

On the bottom surface 30a of the support part 30, the first adhesive material 50 for temporarily fixing the cover member 20 to the bottom surface 30a is applied to the positions corresponding to the corners of the cover member 20 (see FIG. 3, etc.) in the state where the element substrate unit 4 is in place.

The first adhesive material 50 is preferably a material that cures quickly upon an activation process, such as by light radiation. If the first adhesive material 50 cannot be cured quickly, there is a possibility that the position of the element substrate unit 4 may shift while the first adhesive material 50 is being cured due to factors such as external force, the self-weight of the element substrate unit 4, and changes in environmental temperature. Therefore, in the present embodiment, a rapid UV-curable adhesive material is used as the first adhesive material 50. However, there are no limitations on the adhesive material that can be used as the first adhesive material 50 as long as it is a rapid-curable adhesive material. Examples of the adhesive material that can be used as the first adhesive material 50 include rapid photo-curable adhesive materials such as rapid visible light photo-curable adhesive materials.

By temporarily fixing the cover member 20 to the bottom surface 30a using the first adhesive material 50 that can be quickly cured, it is possible to prevent misalignment of the element substrate unit 4 while the element substrate unit 4 is being fixed to the support part 30.

On the bottom surface 32a of the recess portion 32, the second adhesive material 60 for temporarily fixing the element substrate 10 (see FIG. 3, etc.) to the bottom surface 32a is applied along the transverse direction (the X direction) at both ends of the longitudinal direction (the Y direction).

In principle, the second adhesive material 60 is preferably a rapid-curable adhesive material as well in order to suppress misalignment of the element substrate unit 4. However, in the present embodiment, the outer periphery of the cover member 20 is longer than the outer periphery of the recess portion 32. Therefore, in the state where the element substrate unit 4 is in place, the opening of the recess portion 32 is covered by the cover member 20. Accordingly, even though light for curing the second adhesive material 60 is irradiated in the state where the element substrate unit 4 is in place, the light is blocked by the cover member 20. In this way, in the present embodiment, it is difficult to cure the second adhesive material 60 after the element substrate unit 4 is placed.

Therefore, in the present embodiment, a delayed UV-curable adhesive material is used as the second adhesive material 60. The delayed UV-curable adhesive material is activated upon irradiation with ultraviolet rays, and thickens and cures after a certain period of time passes. In this way, by irradiating ultraviolet rays onto the delayed UV-curable adhesive material used as the second adhesive material 60 and then placing the element substrate unit 4, it is possible to temporarily fix the element substrate 10 to the bottom surface 32a. By temporarily fixing the element substrate 10 in advance at the end of the bottom surface 32a, it is possible to further suppress misalignment of the element substrate unit 4 while fixing the element substrate unit 4 at the center of the bottom surface 32a.

Note that the adhesive material that can be used as the second adhesive material 60 is not limited to the delayed UV-curable adhesive material as long as it can temporarily fix the element substrate 10. Examples of adhesive materials that can be used as the second adhesive material 60 include delayed photo-curable adhesive materials such as delayed visible light photo-curable adhesive materials.

The third adhesive material 40 for firmly fixing the element substrate 10 to the bottom surface 32a is applied to the center of the bottom surface 32a so as to surround the vicinity of the flow path openings 31. However, in order to prevent the third adhesive material 40 from entering the flow path openings 31, it is preferable not to apply the third adhesive material 40 to the edges of the flow path openings 31.

In the present embodiment, a thermosetting adhesive material that cures at a temperature of about 100 to 150 degrees is used as the third adhesive material 40.

As described above, the third adhesive material 40 is applied to the vicinity of the flow path openings 31. Therefore, during use of the liquid ejection head 3 (see FIG. 1, etc.), there is a possibility that the liquid passing through the flow path openings 31 may come into contact with the cured third adhesive material 40 (the third adhesive layer).

In order to maintain the state in which the element substrate 10 is firmly fixed to the bottom surface 32a even if liquid comes into contact with the third adhesive layer, it is preferable that the third adhesive material 40 has liquid resistance, sealing properties, and swelling properties, as well as the fixing strength to firmly fix the element substrate 10. For example, in a case where ink is used as the liquid, the third adhesive material 40 preferably has ink resistance, sealing properties, and swelling properties against the ink. Note that the third adhesive material 40 does not need to be a photo-curable adhesive material nor a delayed-curable adhesive material.

By using the third adhesive material 40 that cures within the above-mentioned temperature range, it is possible to ensure liquid resistance, sealing properties, and swelling properties. This allows the product life to be extended compared with a case in which the third adhesive material 40 does not have the liquid resistance, sealing properties, and swelling properties. Note that the second adhesive material 60 is applied to a position farther away from the flow path openings 31 compared with the third adhesive material 40. Therefore, the second adhesive material 60 does not need to have as excellent liquid resistance, sealing properties, and swelling properties as the third adhesive material 40.

Further, the first adhesive material 50 is applied to a position farther away from the flow path openings 31 compared with the second adhesive material 60. Furthermore, the position to which the first adhesive material 50 is applied is at a different height (position in the Z direction) from the positions to which the second adhesive material 60 and the third adhesive material 40 are applied. Therefore, as with the second adhesive material 60, the first adhesive material 50 also does not need to have as excellent liquid resistance, sealing properties, and swelling properties as the third adhesive material 40.

In general, UV-curable adhesive materials tend to be inferior to thermosetting adhesive materials in terms of liquid resistance and swelling properties. However, as described above, in the present embodiment, the first adhesive material 50 and the second adhesive material 60 are applied to positions sufficiently far away from the flow path openings 31. Therefore, there is no problem even if UV-curable adhesive materials are used as the first adhesive material 50 and the second adhesive material 60.

Referring again to FIG. 6, the description of the process for producing the liquid ejection head 3 is continued.

In S602, the second adhesive material 60 is activated.

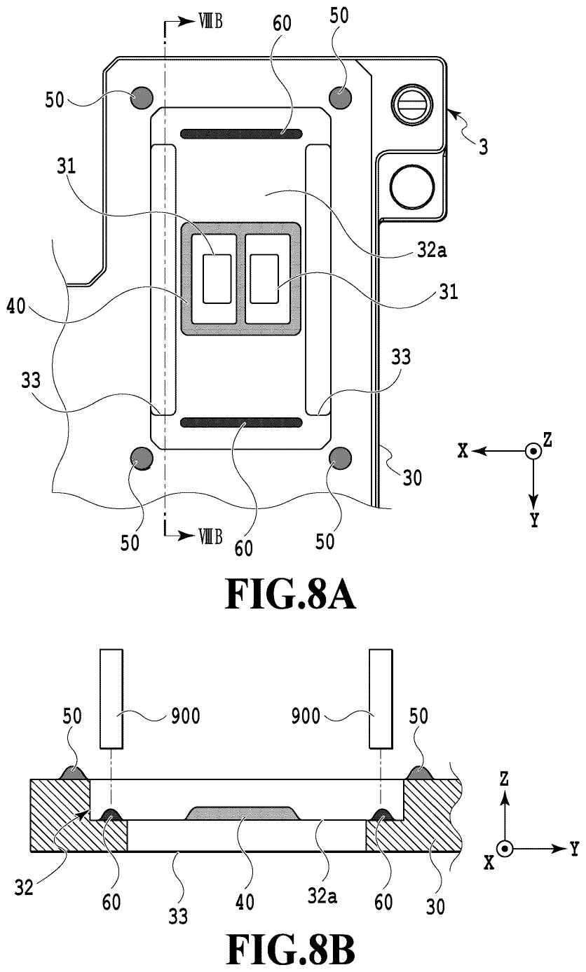

FIG. 8A is a bottom view of the support part 30 after adhesive materials have been applied. FIG. 8B is a cross-sectional view taken along line VIIIb-VIIIb of FIG. 8A.

As illustrated in FIG. 8A and FIG. 8B, the light sources 900 are used to irradiate the second adhesive material 60 with light. As described above, in the present embodiment, a delayed UV-curable adhesive material is used as the second adhesive material 60. Therefore, in the present embodiment, the light sources 900 irradiate the second adhesive material 60 with ultraviolet rays. This activates the second adhesive material 60. Note that, in order to prevent the first adhesive material 50 from curing, it is preferable to prepare a mask (not illustrated in the drawings) on the first adhesive material 50. Note that, in a case where visible light photo-curable adhesive materials are used as the first adhesive material 50 and the second adhesive material 60, the light sources 900 emit visible light.

In the present embodiment, as described above, a delayed UV-curable adhesive material is used as the second adhesive material 60. Therefore, the viscosity of the second adhesive material 60 does not change immediately after irradiation with ultraviolet rays. For example, after about 5 to 20 minutes have passed since the irradiation of the second adhesive material 60 with ultraviolet rays, the second adhesive material 60 thickens and cures.

Referring again to FIG. 6, the description of the process for producing the liquid ejection head 3 is continued.

In S603, the element substrate unit 4 is placed on the support part 30.

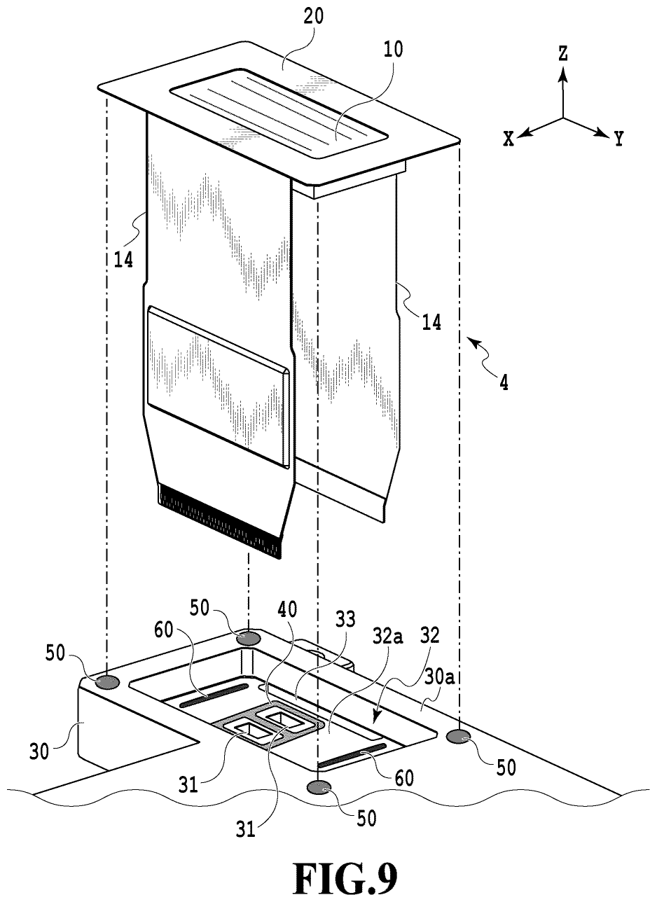

FIG. 9 is an explanatory diagram of S603.

As illustrated in FIG. 9, the element substrate unit 4 is positioned and placed on the support part 30 so that the corners of the cover member 20 come into contact with the first adhesive material 50. Note that, in order to place the element substrate unit 4 on the support part 30, a predetermined placement device (not illustrated in the drawings) is used.

According to this method, the first adhesive material 50 adheres to the cover member 20 in the state where the element substrate unit 4 is placed on the support part 30. Further, the second adhesive material 60 and the third adhesive material 40 adhere to the element substrate 10.

In addition, placing the element substrate unit 4 must be performed before the activated second adhesive material 60 thickens and cures. This is because, if the second adhesive material 60 thickens and cures, it is difficult to place the element substrate unit 4 on the support part 30.

Referring again to FIG. 6, the description of the process for producing the liquid ejection head 3 is continued.

In S604, the first adhesive material 50 is cured.

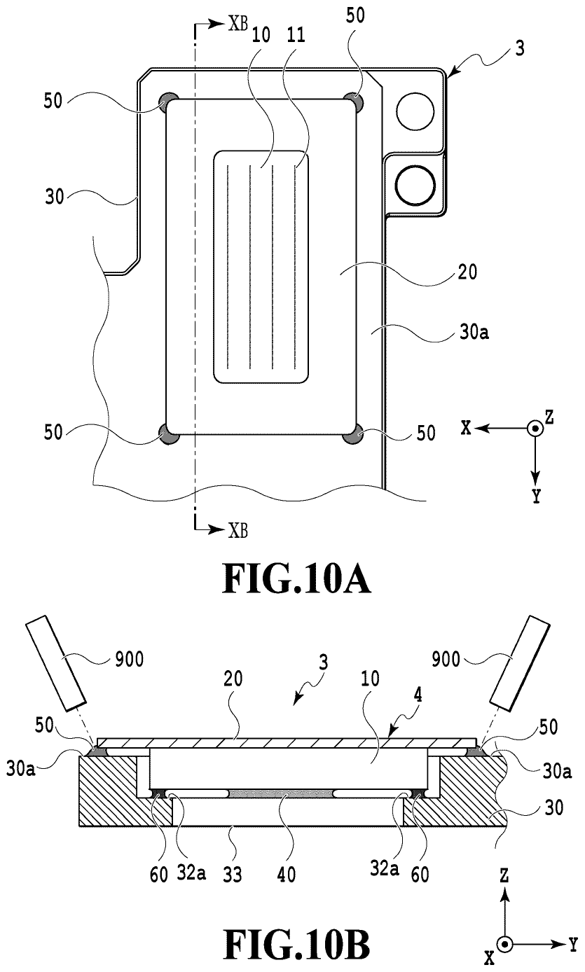

FIG. 10A is a schematic bottom view of the liquid ejection head 3 after the element substrate unit 4 is placed. FIG. 10B is a cross-sectional view taken along line Xb-Xb of FIG. 10A.

As illustrated in FIG. 10A and FIG. 10B, the first adhesive material 50 is irradiated with ultraviolet rays from the light sources 900 to cure the first adhesive material 50.

In the example of FIG. 10B, ultraviolet rays are irradiated from above the cover member 20 with the light sources 900 tilted relative to the bottom surface 30a of the support part 30, but the positions and angles at which the light sources 900 are placed are not limited to this example.

For example, ultraviolet rays may be irradiated from the sides of the support part 30 along the Y direction, or ultraviolet rays may be irradiated from the front or back of the support part 30 along the X direction. According to these methods, even in a case where the first adhesive material 50 does not protrude outward from the corners of the cover member 20 in the state where the element substrate unit 4 is in place, the first adhesive material 50 located between the bottom surface 30a and the cover member 20 can be cured.

By curing the first adhesive material 50, the cover member 20 is temporarily fixed to the bottom surface 30a. By temporarily fixing the cover member 20, it is possible to prevent the position of the element substrate 10 from shifting while the element substrate 10 is being firmly fixed to the bottom surface 32a.

In the present embodiment, the element substrate unit 4 is located at the most accurate target position relative to the support part 30 immediately after the element substrate unit 4 is placed by the above-mentioned placement device. Therefore, it is preferable that the element substrate unit 4 does not move as much as possible from the position immediately after the placement.

As described above, the third adhesive material 40 is a thermosetting adhesive material. Therefore, there is a possibility that the element substrate 10 and the cover member 20 may undergo linear expansion while the third adhesive material 40 is being heated. Since the volumes of the support part 30 and the element substrate unit 4 change due to the linear expansion, if no measures are taken to deal with the linear expansion of these, there is a possibility that the element substrate unit 4 may shift from its most accurate position located immediately after the placement.

Therefore, in the present embodiment, the first adhesive material 50 is used, which can be quickly cured by irradiating it with ultraviolet rays in a normal temperature environment. According to this method, the environmental temperature does not change from immediately after the element substrate unit 4 is placed, and thus the problem relating to linear expansion of the element substrate 10 and the cover member 20 does not occur.

Furthermore, since the first adhesive material 50 cures immediately upon irradiation with ultraviolet rays, the most accurate position of the element substrate unit 4 immediately after placement can be easily maintained.

Note that, in a case where multiple element substrate units 4 are placed on one support part 30, the steps of S602 to S604 are performed for each of the element substrate units 4.

Referring again to FIG. 6, the description of the process for producing the liquid ejection head 3 is continued.

In S605, the curing of the second adhesive material 60 (see FIG. 10B, etc.) is completed. Even if the second adhesive material 60 is left at normal temperature after the second adhesive material 60 is irradiated with ultraviolet ray, it is possible to cure the second adhesive material 60. However, by heating the second adhesive material 60 at a low temperature of about 40 to 50 degrees after irradiating the second adhesive material 60 with ultraviolet rays, activation of the second adhesive material 60 is promoted. This allows the second adhesive material 60 to cure faster than leaving it at normal temperature. Therefore, in S605 of the present embodiment, the second adhesive material 60 is cured by low-temperature heating. By curing the second adhesive material 60, the element substrate 10 (see FIG. 10B, etc.) can be temporarily fixed to the bottom surface 32a (see FIG. 10B, etc.).

As described above, at the point in time where the present step is performed, the cover member 20 (see FIG. 10B, etc.) is temporarily fixed. However, fundamentally, it is the element substrate 10, not the cover member 20, that should be positioned with high precision.

As described above, the element substrate 10 is firmly fixed by the thermosetting third adhesive material 40 (see FIG. 10B, etc.). If the third adhesive material 40 is heated for firm fixation, there is a possibility that the position of the element substrate 10 may shift due to the difference in the amounts of change in linear expansion, which is caused by the difference in the linear expansion coefficients between the element substrate 10 and the cover member 20. The height (position in the Z direction) at which the element substrate 10 is located and the height (position in the Z direction) at which the cover member 20 is located are different from each other. The stress generated by linear expansion also acts in the height direction (the Z direction). Therefore, due to such factors, there is a possibility that the position of the element substrate 10 may shift as well.

Further, in the support part 30 (see FIG. 10B, etc.), the position in the height direction (the Z direction) at which the third adhesive material 40 is applied is different from the position in the height direction (the Z direction) at which the first adhesive material 50 (see FIG. 10B, etc.) is applied. If the third adhesive material 40 is heated in the state where the positions in the height direction at which the third adhesive material 40 and the first adhesive material 50 are applied are different from each other, torque may be generated in the YZ plane and the XZ plane of the support part 30. The action of this torque may cause the position of the element substrate 10 to shift.

Therefore, in the present embodiment, the element substrate 10 is temporarily fixed to the same plane as the plane on which the element substrate 10 will be firmly fixed (that is, the bottom surface 32a, which is the XY plane). This allows the element substrate 10 to be temporarily fixed more securely compared with the case where only the cover member 20 is temporarily fixed. Therefore, with this configuration, it is possible to suppress misalignment of the element substrate 10.

In the present embodiment, the second adhesive material 60 is cured by heating it at a temperature of about 40 to 50 degrees. In a case where the temperature at which the second adhesive material 60 is heated is within the above-mentioned temperature range, the possibility that the problems relating to the linear expansion of the element substrate 10 and the cover member 20 will occur is reduced. In this way, by heating the second adhesive material 60 at a relatively low temperature, the second adhesive material 60 can be cured more quickly compared with a case where the second adhesive material 60 is not heated.

There are no limitations on the adhesive material that can be used as the second adhesive material 60 as long as it does not cause the above-mentioned problems relating to linear expansion. For example, a two-liquid curing type adhesive material may be used as the second adhesive material 60. With this configuration, although it requires a longer time period compared with a case where the second adhesive material 60 is heated, the second adhesive material 60 can be cured without causing problems relating to linear expansion in the element substrate 10 and the cover member 20.

In S606, the third adhesive material 40 (see FIG. 10B, etc.) is cured.

In the present embodiment, the third adhesive material 40 is cured by heating it at a temperature of about 100 to 150 degrees, thereby firmly fixing the element substrate 10 to the bottom surface 32a (see FIG. 10B, etc.). However, the temperature at which the third adhesive material 40 is heated is not limited to this example as long as the element substrate 10 can be firmly fixed to the bottom surface 32a.

As described above, if the outer periphery of the element substrate unit 4 is unstable, there is a possibility that the position of the element substrate 10 (see FIG. 10B, etc.) may shift due to the heating of the third adhesive material 40. However, in the present embodiment, temporary fixation is performed using the first adhesive material 50 (see FIG. 10B, etc.) and the second adhesive material 60 (see FIG. 10B, etc.), and thus misalignment of the element substrate 10 is suppressed.

The above is an explanatory diagram of the process for producing the liquid ejection head 3 (see FIG. 10B, etc.) that can be applied to the present embodiment. Note that the order in which the steps in the above-described flowchart are performed may be changed as long as the liquid ejection head 3 of the present embodiment can be produced. Further, some of the above-described several steps may be performed simultaneously. Furthermore, if the second adhesive material 60 activated in S602 has appropriately cured between S604 and S606, the step of S605 does not need to be performed.

As described above, in the present embodiment, a rapid-curable adhesive material is used as the first adhesive material 50 for temporarily fixing the cover member 20 (see FIG. 10B, etc.), and a delayed-curable adhesive material is used as the second adhesive material 60 for temporarily fixing the element substrate 10. As a result, even if the second adhesive material 60 is covered by the cover member 20 in the state where the element substrate unit 4 (see FIG. 10B, etc.) is placed on the support part 30, the element substrate 10 can be firmly fixed in the state where the cover member 20 and the element substrate 10 are temporarily fixed. Therefore, the position of the element substrate unit 4 is prevented from shifting relative to the support part 30 while the element substrate 10 is being firmly fixed.

Thus, according to the process for producing a liquid ejection head of the present embodiment, an element substrate unit can be fixed to a support part with high precision.

### First Modification Example of the First Embodiment

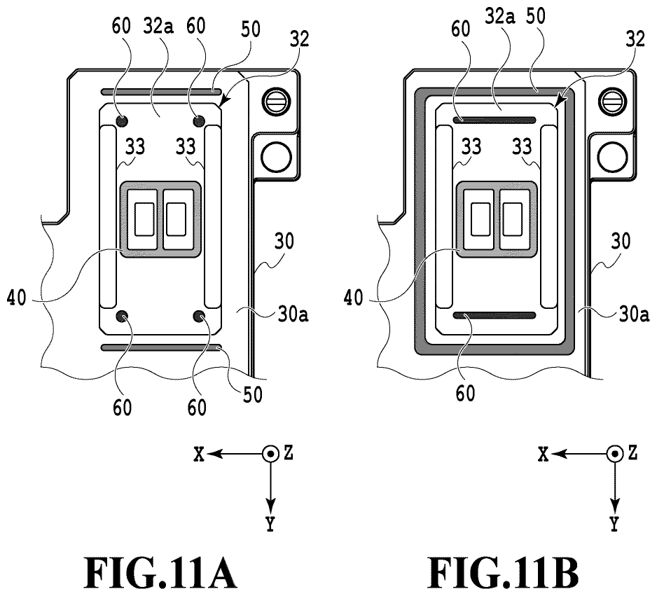

FIG. 11A is a diagram illustrating a first modification example of S601.

As illustrated in FIG. 11A, the second adhesive material 60 may be applied to the positions corresponding to the corners of the element substrate 10 (see FIG. 3, etc.) on the bottom surface 32a of the recess portion 32 formed in the support part 30. According to this method, the amount of second adhesive material 60 to be applied can be reduced compared with the example of FIG. 7.

### Second Modification Example of the First Embodiment

FIG. 11B is a diagram illustrating a second modification example of S601.

As illustrated in FIG. 11B, the first adhesive material 50 may be applied along the opening of the recess portion 32 on the bottom surface 30a of the support part 30. Note that, in order to prevent the first adhesive material 50 from adhering to the inside of the recess portion 32 and prevent the flexible wiring substrates 14 from being fixed to unintended locations with the first adhesive material 50, it is preferable not to apply the first adhesive material 50 to the edge of the opening of the recess portion 32.

This method makes it possible to prevent liquid adhering to the ejection ports 11 (see FIG. 2, etc.) and mist generated upon liquid ejection from entering the interior of the recess portion 32 through the gap between the cover member 20 (see FIG. 3, etc.) and the bottom surface 30a. This makes it possible to prevent the liquid from adhering to electrical wiring parts (for example, the flexible wiring substrates 14 (see FIG. 3, etc.)) installed inside the liquid ejection head 3 (see FIG. 1, etc.). That is, the occurrence of electrical defects can be suppressed.

### Second Embodiment

The present embodiment aims to provide the liquid ejection head 3 capable of fixing the element substrate unit 4 more securely to the support part 30. In the following description, the same of corresponding configurations of those in the first embodiment are denoted by the same signs, thereby omitting descriptions thereof, so that a description is mainly given of the different points.

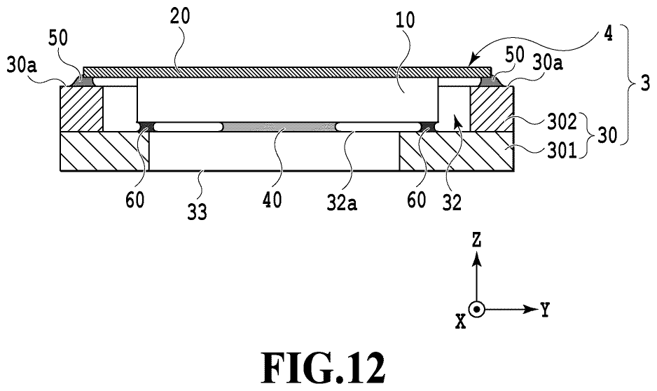

FIG. 12 is a schematic cross-sectional view of the liquid ejection head 3 that can be applied to the present embodiment. Note that FIG. 12 corresponds to line Xb-Xb of FIG. 10A.

As illustrated in FIG. 12, in the present embodiment, the support part 30 includes the first support part 301 and the second support part 302. The recess portion 32 is formed by laminating the second support part 302 on the first support part 301. In this manner, the support part 30 of the present embodiment is configured by separately producing each of the first support part 301 and the second support part 302 and then laminating them.

This makes it easier to process a surface of the second support part 302 than in the first embodiment, for example. Specifically, by a process of polishing the surface of the second support part 302 to which the first adhesive material 50 is applied (i.e., the surface used as the bottom surface 30a of the support part 30), the flatness of the surface to which the first adhesive material 50 is applied can be improved. By improving the flatness of the bottom surface 30a, the plurality of element substrate units 4 can be placed in parallel at the time of placing the element substrate units 4, and thus the quality of printed images can be improved.

Therefore, according to the liquid ejection head 3 of the present embodiment, the element substrate unit 4 can be fixed more firmly to the support part 30.

### Third Embodiment

The present embodiment aims to provide the liquid ejection head 3 capable of fixing the element substrate unit 4 to the support part 30 with high precision. In the following description, the same of corresponding configurations of those in the first embodiment are denoted by the same signs, thereby omitting descriptions thereof, so that a description is mainly given of the different points.

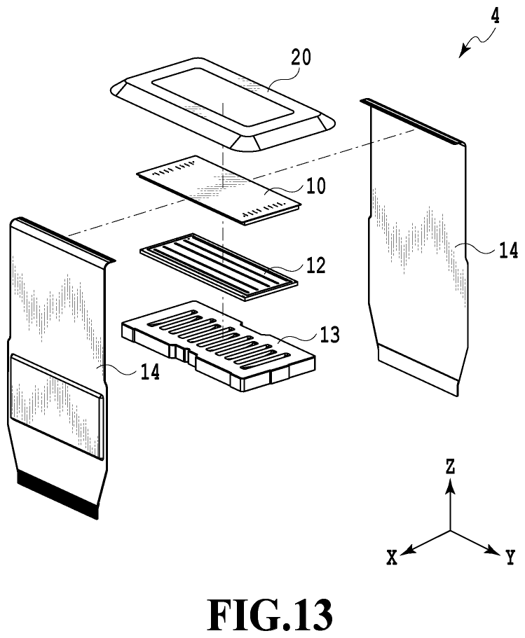

FIG. 13 is an exploded perspective view of the element substrate unit 4 that can be applied to the present embodiment.

As illustrated in FIG. 13, the element substrate unit 4 of the present embodiment includes the flow path member 13 equipped with flow paths formed along the short side direction (the X direction), and the flow path conversion substrate 12 equipped with flow paths that convert the direction in which the liquid supplied from the flow path member 13 flows to the longitudinal direction (the Y direction).

In the present embodiment, the flow path member 13, the flow path conversion substrate 12, the element substrate 10, and the cover member 20 are laminated in this order, and the flexible wiring substrates 14 are connected to the element substrate 10, thereby configuring the element substrate unit 4.

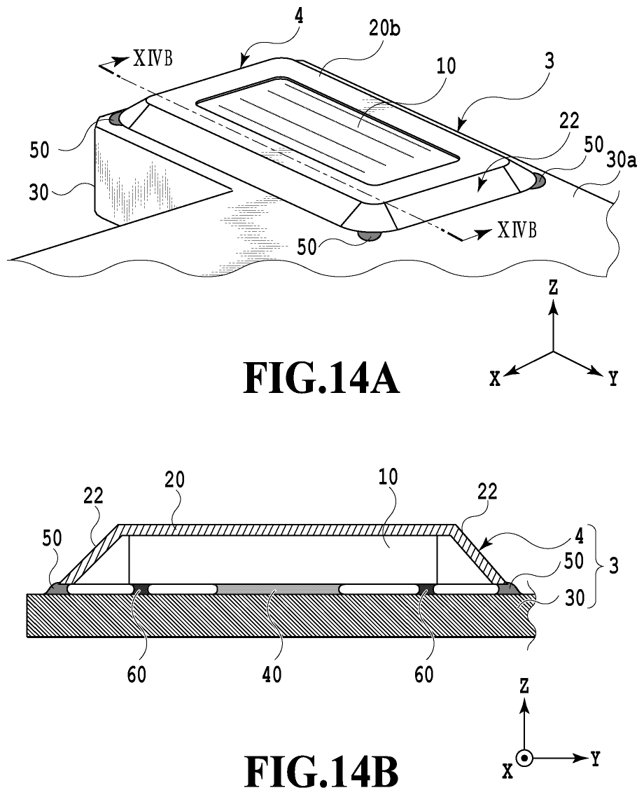

FIG. 14A is a schematic perspective view of the bottom surface of the liquid ejection head 3 that can be applied to the present embodiment.

In the present embodiment, the support part 30 is not equipped with the recess portion 32 (see FIG. 7, etc.). The flow path openings 31 (see FIG. 7, etc.) are formed in the bottom surface 30a. The cover member 20 is equipped with the inclined portion 22 that is inclined relative to the bottom surface 30a in the state where the element substrate unit 4 is fixed to the support part 30. In the element substrate unit 4, the inclined portion 22 is formed from the center of the cover member 20 toward the periphery so as to approach the element substrate 10.

With this configuration, even if a wiper (not illustrated in the drawings) comes into contact with the element substrate unit 4 to wipe off liquid adhering to the element substrate 10 during maintenance, the impact of the contact is absorbed by the inclined portion 22. Therefore, compared with a configuration in which the inclined portion 22 is not formed, the impact at the time the wiper comes into contact can be reduced. This improves the durability of the wiper, and thus it is possible to obtain the effect of suppressing deterioration in maintainability caused by damage to the wiper and suppressing dust generation by the wiper. In addition, it is also possible to obtain the effect that the element substrate unit 4 is less likely to be damaged.

FIG. 14B is a cross-sectional view taken along line XIVb-XIVb of FIG. 14A.

As illustrated in FIG. 14B, in the present embodiment, the first adhesive material 50, the second adhesive material 60, and the third adhesive material 40 are applied to the bottom surface 30a. The second adhesive material 60 and the third adhesive material 40 are applied to the inside of the cover member 20. Therefore, in the present embodiment, if the second adhesive material 60 and the third adhesive material 40 have cured, an adhesive layer of the second adhesive material 60 and an adhesive layer of the third adhesive material 40 are formed on the inside of the cover member 20.

Even with this configuration, by using a delayed UV-curable adhesive material as the second adhesive material 60, the element substrate unit 4 can be fixed to the support part 30 with high precision.

### Other Embodiments

In the above embodiments, the liquid ejection head 3 is configured to be capable of ejecting four types of liquid. However, the form of the liquid ejection head 3 is not limited to the above-described form as long as the liquid ejection head 3 is capable of ejecting one or more types of liquid. For example, the liquid ejection head 3 may be configured to be capable of ejecting only black ink, or may be configured to be capable of ejecting ink of more colors than the above-described four colors.

In the above embodiments, a cut sheet is used as the printing medium P. However, it is also possible to use a roll sheet as the printing medium P.

In the above embodiments, the description is given that a rapid-curable adhesive material such as a rapid UV-curable adhesive material can be used as the first adhesive material 50. However, the first adhesive material 50 does not necessarily need to have rapid curability. For example, a normal temperature curable type adhesive material, a moisture curable type adhesive material, a two-liquid blending type adhesive material, or the like may be used as the first adhesive material 50. However, these adhesive materials require a longer time period for curing, compared with rapid-curable adhesive materials. Therefore, in a case where a rapid-curable adhesive material is not used as the first adhesive material 50, there is a possibility that the position of the cover member 20 may shift while the adhesive material is curing due to factors such as the self-weight of the cover member 20, external forces, and changes in environmental temperature. Thus, it is preferable that the first adhesive material 50 has rapid curability.

In the above embodiments, a thermosetting adhesive material that cures at a relatively high temperature is used as the third adhesive material 40. However, there are no limitations on the third adhesive material 40 as long as it can firmly fix the element substrate 10. For example, a normal temperature curable type adhesive material, a thermosetting adhesive material that cures at a relatively low temperature (specifically, between about 40 to 50 degrees), a two-liquid blending type adhesive material, or the like may be used as the third adhesive material 40. These adhesive materials do not require high-temperature heating, and thus linear expansion of the cover member 20 and the element substrate 10 can be avoided. Therefore, if a normal temperature curable type adhesive material or the like is used as the third adhesive material 40, it will require a longer time period for curing, but it will be possible to suppress misalignment of the element substrate unit 4 due to linear expansion of the cover member 20 and the element substrate 10.

According to a process for producing a liquid ejection head of the present disclosure, an element substrate unit can be fixed to a support part with high precision.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-223993, filed Dec. 19, 2024, which is hereby incorporated by reference herein in its entirety.

What is claimed is:

1. A process for producing a liquid ejection head equipped with:
an element substrate unit configured to include an element substrate and a cover member, the element substrate including an energy generating element that generates energy for ejecting liquid, the cover member being configured to surround a periphery of the element substrate and have an opening that does not cover an ejection port for ejecting liquid formed in the element substrate; and
a support part configured to support the element substrate unit,
the process comprising the step of:
applying, to the support part, a first adhesive material for fixing the cover member, and a second adhesive material and a third adhesive material for fixing the element substrate;
activating the second adhesive material by irradiating the second adhesive material with light;
placing the element substrate unit on the support part such that the second adhesive material is covered with the cover member;
curing the first adhesive material; and
curing the third adhesive material,
wherein the activating of the second adhesive material is performed prior to the placing of the element substrate unit, and
wherein the curing of the third adhesive material is performed after the curing of the first adhesive material.

2. The process for producing the liquid ejection head according to claim 1,
wherein, in the applying, a delayed photo-curable adhesive material, which requires a longer time period to be cured than the first adhesive material, is applied as the second adhesive material.

3. The process for producing the liquid ejection head according to claim 1,
wherein, in the applying, a rapid photo-curable adhesive material, which can be cured in a shorter time period than the second adhesive material, is applied as the first adhesive material, and
wherein, in the curing of the first adhesive material, the first adhesive material is irradiated with light.

4. The process for producing the liquid ejection head according to claim 3,
wherein, in the curing of the first adhesive material, ultraviolet rays are irradiated as the light.

5. The process for producing the liquid ejection head according to claim 1,
wherein, in the activating, ultraviolet rays are irradiated as the light.

6. The process for producing the liquid ejection head according to claim 1,
wherein the cover member is made of a material that does not transmit light.

7. The process for producing the liquid ejection head according to claim 1,
wherein the third adhesive material is a thermosetting adhesive material, and
wherein, in the curing of the third adhesive material, the third adhesive material is heated.

8. The process for producing the liquid ejection head according to claim 1,
wherein the support part has a flow path opening connected to a flow path formed in the element substrate,
wherein the third adhesive material has liquid resistance, and
wherein, in the applying,
the third adhesive material is applied so as to surround the flow path opening, and
the second adhesive material is applied at a position farther away from the flow path opening than the third adhesive material.

9. The process for producing the liquid ejection head according to claim 1 further comprising the step of
promoting the activating by heating the second adhesive material.

10. A liquid ejection head equipped with:
an element substrate unit configured to include an element substrate and a cover member, the element substrate including an energy generating element that generates energy for ejecting liquid, the cover member being configured to surround a periphery of the element substrate and have an opening that does not cover an ejection port for ejecting liquid formed in the element substrate; and
a support part configured to support the element substrate unit,
the liquid ejection head comprising:
a first adhesive layer configured to be formed between the support part and the cover member and to include a first adhesive material;
a second adhesive layer configured to be covered with the cover member and formed between the element substrate and the support part and to include a second adhesive material that is activated by irradiation with light; and
a third adhesive layer configured to be formed between the support part and the cover member and to include a third adhesive material.

11. The liquid ejection head according to claim 10,
wherein the second adhesive layer includes a component of a delayed photo-curable adhesive material that requires a longer time period to be cured than the first adhesive material.

12. The liquid ejection head according to claim 10,
wherein the first adhesive layer includes a component of a rapid photo-curable adhesive material that can be cured in a shorter time period than the second adhesive material.

13. The liquid ejection head according to claim 10,
wherein the second adhesive material includes a component that promotes curing by heating.

14. The liquid ejection head according to claim 10,
wherein the cover member is made of a material that does not transmit light.

15. The liquid ejection head according to claim 14,
wherein the cover member contains at least any one of titanium, a nickel alloy, stainless steel, tungsten, molybdenum, and ceramics.

16. The liquid ejection head according to claim 10,
wherein the third adhesive material is a thermosetting adhesive material.

17. The liquid ejection head according to claim 10,
wherein the support part has a flow path opening connected to a flow path formed in the element substrate,
wherein the third adhesive layer has liquid resistance,
wherein the third adhesive material is formed so as to surround the flow path opening, and
wherein the second adhesive layer is formed at a position farther away from the flow path opening than the third adhesive layer.

18. The liquid ejection head according to claim 17,
wherein the flow path opening is formed in a bottom surface of a recess portion, which is formed in the support part.

19. The liquid ejection head according to claim 18,
wherein the second adhesive layer and the third adhesive layer are located on the same plane.

20. The liquid ejection head according to claim 10,
wherein the first adhesive layer, the second adhesive layer, and the third adhesive layer are formed on the same plane, and
wherein the cover member has an inclined portion configured to be inclined relative to the plane so as to approach the element substrate.
